(19) United States
(12) Patent Application Publication
(10) Pub. No.: US 2004/0080950 A1
(43) Pub. Date: Apr. 29, 2004

(54) Automatic restoring device of foldable lampshade

(76) Inventor: Shih-Ming Lin, Chung-Hua (TW)

Correspondence Address: Shih-Ming Lin, 235 Chung-Ho, Box 8-24, Taipei, TW

(21) Appl. No.: 10/282,302

(22) Filed: Oct. 29, 2002

(51) Int. Cl. F21V 1/06

(52) U.S. Cl. 362/352

(57) ABSTRACT

An automatic restoring device of a foldable lampshade comprises: a top ring; a bottom ring; a supporting stand installed between the top ring and the bottom ring. The supporting stand further comprising an elastic steel member disposed individually on a top and a bottom of the supporting stand, and a flexible bar sheathed into the elastic steel member. The steel member is a coiled spring bar. The flexible bar is bent into a predetermined curve firstly to resist against the elastic steel member and fix into a position between the top ring and the bottom ring according to the change of arc shape of the elastic bar. The lampshade is wrapped around peripheries of the top ring and the bottom ring, and fixes the elastic steel member to a latching position of the top and bottom rings.

### BACKGROUND OF THE INVENTION

1. Field of the Invention

The present invention relates to lampshades, and particularly to an automatic restoring device of foldable lampshade, such an arrangement provides a simple and easy assembled structure, reduces the volume for storage and transportation, and lowers the transportation cost.

2. Description of the Related Art

The conventional lampshade 5, as shown in FIG. 5, generally has a supporting stand directly fixed between the top ring and the bottom ring to form the lampshade structure. However, since the traditional lampshade 5 is a fixed structure, the lampshade cannot be compressed when being packaged into a carton. Thus the object occupies a lot of space and it is unable to greatly reduce the volume for storage and transportation or reduce the product transportation cost, and thus turns out to be a burden to the cost.

In view of aforementioned shortcomings, the inventor of the present invention based on years of experience accumulated from the engagement in the related industry conducted extensive research and experiment to resolve the aforementioned shortcomings and invented the present invention.

### SUMMARY OF THE INVENTION

The primary objective of the present invention is to provide an automatic restoring device for a foldable lampshade. The device comprises: a top ring; a bottom ring; a supporting stand installed between the top ring and the bottom ring; and a lampshade, wrapped around the periphery of the top ring and the bottom ring; wherein the supporting stand comprises an elastic steel member disposed individually on the top/bottom end of the supporting stand, and a flexible bar sheathed inside the elastic steel member, and the steel body is a coiled spring bar. To cope with the sheathing of the flexible bar inside the elastic steel member, the flexible bar could be bent into the required curve first in order to prop the elastic steel member according to the change of curvature of the elastic bar. When the user wants to fold the lampshade, the user just needs to twist the top ring and press downward, the elastic steel member and the flexible bar are simultaneously compressed and deformed; when the user releases the top ring, the resilent characteristic of the steel member will resume its original position and drive the elastic bar back to the curvature for the propping condition. Such arrangement gives a simple and easy assembly, reduces the volume for storage and transportation, and lowers the transportation cost.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is an explosive view showing the components of the present invention.

FIG. 2 is an assembled view of the present invention.

FIG. 3 is a cross-sectional view of the present invention.

FIG. 4 is a perspective view of the foldable lampshade when it is folded according to the present invention.

FIG. 5 is a perspective view of the prior-art lampshade.

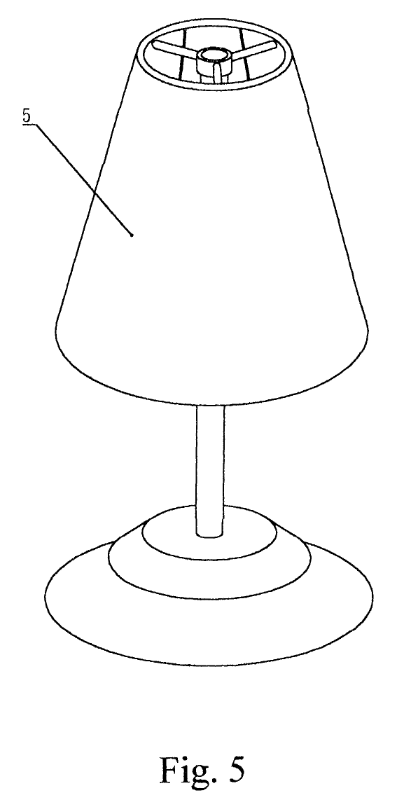

### DETAILED DESCRIPTION OF THE PREFERRED EMBODIMENTS

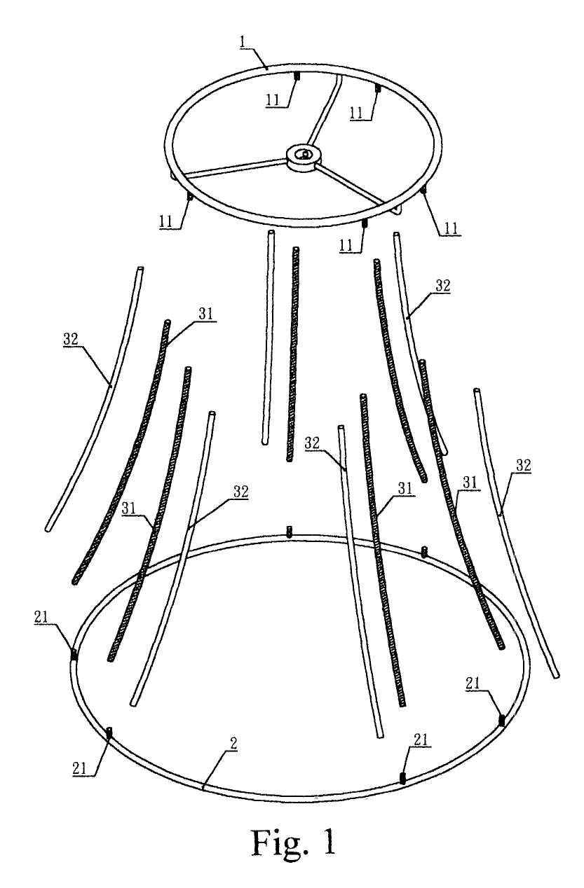

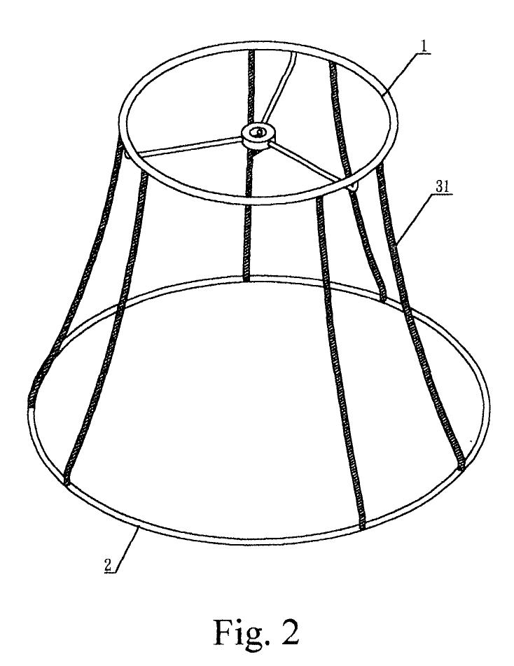

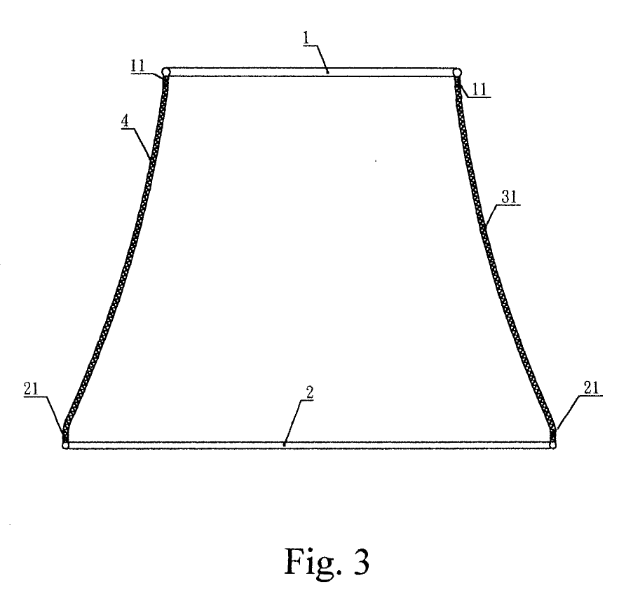

With reference to FIGS. 1 to 3 for a clear understanding of the structural configuration of the present invention, the automatic restoring device of a foldable lampshade comprises a top ring 1; a bottom ring 2; a supporting stand 3, installed between the top ring 1 and the bottom ring 2; and a canopy 4 of the lampshade; wherein: a plurality of screw rod sections 11 protrudes downward sequentially from a bottom of the top ring 1. A diameter of the bottom ring is larger than the diameter of the top ring 1, and the bottom ring 2 also has a plurality of screw rod sections 21 protrudes upwards from the positions aligning with the corresponding screw rod sections 11 at the top ring 2.

The supporting standard 3 comprises an elastic steel member 31 on the top and the bottom of the top ring 1 and bottom ring 2 respectively; and a flexible bar 32 is sheathed inside the elastic steel member 31. The elastic steel member 31 is a hollow coiled spring bar, and the top and bottom coil sections thereof are latched to the screw thread sections (screw thread surface) of the top ring 1 and the bottom ring 2, respectively, such that the elastic steel member 31 is fixed between the top ring 1 and the bottom ring 2. Further to cope with the sheathing of the flexible bar 32 into the inner ring of the elastic steel member 31, the flexible bar 32 could be bent into the required curve firstly in order to prop the elastic steel member 31 according to the change of curvature of the flexible bar 32 and accomplish a curved supporting stand for the top and bottom rings.

The lampshade 4 is wrapped around the peripheries of the top ring 1 and bottom ring 2, and appropriately fixes the elastic steel member 31 with the latching position of the top/bottom rings 1/2. After the lampshade is propped, both ends of the elastic steel member 3 is supported properly to fix the supporting stand 3 into a secure position so as to prevent the top/bottom rings 1/2 from falling apart.

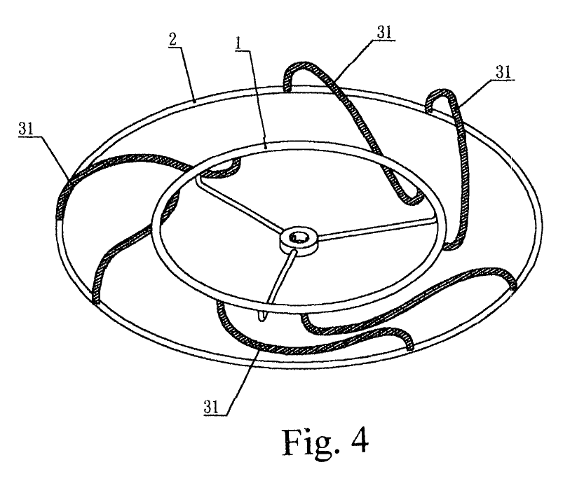

Referring to FIG. 4, the movement of the preferred embodiment of the present invention is illustrated. By means of the latch of the elastic steel member 31 between the top ring 1 and the bottom rings 2 and structural characteristic of a flexible bar 32 which is sheathed into the elastic steel member 31, the user just needs to twist and press down the top ring 1 when the user wants to fold the lampshade. Then the elastic steel member 31 and the flexible bar 32 are simultaneously compressed and deformed so that the top ring 1 can be pressed to the same plane of the bottom ring 2 to facilitate the folding of the lampshade and reducing the volume for storage and transportation.

After the user releases the top ring 1, the resilient feature of the steel member 31 will restore to the original position thereof and drive the elastic bar 32 back to a curvature of a resisting condition. Such arrangement gives a simple and easy assembly, reduces the volume for storage and transportation, and lowers the transportation cost.

In summation of the above description, the “Automatic restoring device of foldable lampshade” of the present invention herein enhances the performance than the conventional structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications, similar arrangements and procedures, and the scope of the appended claims therefore should be accorded the broadest interpretation so as to encompass all such modifications and similar arrangements and procedures.

What is claimed is:

1. An automatic restoring device of a foldable lampshade, comprising: a top ring; a bottom ring; a supporting stand installed between the top ring and the bottom ring; characterized in that:
the supporting stand further comprising an elastic steel member disposed individually on a top and a bottom of the supporting stand, and a flexible bar sheathed into the elastic steel member, and the steel member being a coiled spring bar; the flexible bar is bent into a predetermined curve firstly to resist against the elastic steel member and fix into a position between the top ring and the bottom ring according to the change of arc shape of the elastic bar;
the lampshade is wrapped around peripheries of the top ring and the bottom ring, and fixes the elastic steel member to a latching position of the top/bottom rings; and
wherein when the lampshade is folded, it is only necessary to twist and press down the top ring so that the elastic steel member and the flexible bar are simultaneously compressed and deformed; when the user releases the top ring, by a resilience force, the steel member restores to an original position thereof; such an arrangement gives a simple and easy assembly, reduces the volume for storage and transportation, and lowers the transportation cost.

2. An automatic restoring device of a foldable lampshade as claimed in claim 1, wherein said top ring comprises a plurality of screw rod sections protruded downward arranged sequentially from a bottom of the top ring; and said bottom ring comprises a plurality of screw rod sections protruded upward arranged sequentially from the bottom ring at the position corresponding to the screw rod sections protruded downward from the top ring; the position at the top and bottom of the elastic steel member being latched to a screw thread section of the top and bottom rings to fix the elastic steel member to the top and bottom ring respectively.

3. An automatic restoring device of a foldable lampshade as claimed in claim 1, wherein said elastic steel member is a hollow coiled spring bar.

4. An automatic restoring device of a foldable lampshade as claimed in claim 1, wherein after the lampshade is ejected, it resists against to both ends of the elastic steel member to fix the supporting stand so as to prevent the elastic steel member from being separated from the top ring and the bottom ring.
